(19) United States
(12) Patent Application Publication
(10) Pub. No.: US 2009/0255747 A1
(43) Pub. Date: Oct. 15, 2009

(54) 3-Wheeled stand-up personal mobility vehicle and components therein

(75) Inventors: Michael Edward Kasaba, Topanga, CA (US); Brian Robert Huff, Newbury Park, CA (US); Aaron James Lehnhardt, Mission Viejo, CA (US)

Correspondence Address: Michael Kasaba, President;RideVehicles LLC, 3991 Camino Ranchero, Camarillo, CA, 93012, US

(73) Assignee: RideVehicles LLC

(21) Appl. No.: 12/082,443

(22) Filed: Apr. 10, 2008

(51) Int. Cl. B62K 15/00; B60K 1/00; B62K 21/16

(52) U.S. Cl. 180/208; 74/551.7; 74/551.3

(57) ABSTRACT

An electric vehicle with a modular frame that includes a main chassis with a rider platform (standing position), front fork/wheel assembly, handlebar assembly, and rear trailing arm assembly with left and right rear wheels. The front fork assembly bolts to the main chassis. The handlebar assembly fastens to the pivoting steer tube of the front fork assembly. The trailing arm assembly bolts to the main chassis and pivots to provide rear suspension for the vehicle. The trailing arm includes a stabilizer bar connecting the right and left trailing arms. Electronics enclosures are integral to the main chassis and are structural members of the vehicle. The battery pack can be installed or removed from the main chassis with a hand-activated latch. The electronics plate contains traction system electronics and is removable from the main chassis. The handle bar assembly includes a folding mechanism.

### FIELD OF THE INVENTION

The present invention relates generally to an electric vehicle and more particularly to an electric vehicle with a standing rider.

### BACKGROUND OF THE INVENTION

In the field of electric vehicles and more particularly two and three-wheeled electric scooters, previous inventors have created many designs for chassis, suspension, and electric powertrains. These designs have often resulted in problems such as vehicle instability, rider fatigue, steep learning curves, electronics that are vulnerable to inclement weather, time-consuming assembly, complex maintenance procedures, and awkward or costly shipping.

In light of this, the inventors, based on the experiences of designing and developing related products for many years, aimed at the above problems, and after detailed design and cautious evaluation, ultimately obtained an invention of real practicability.

### BRIEF SUMMARY OF THE INVENTION

The facts of improving functionality and effectiveness by this invention follow.

Mainly through such improved design, the vehicle is more stable and less likely to tip over when the rider turns the vehicle, the rider experiences less fatigue, routine maintenance and repair are made easier, shipping costs are reduced, electronics are less vulnerable to water damage or severe impact and manufacturing costs are reduced.

The trailing arm assembly is made up of two trailing arms and a stabilizer tube affixed between them. The trailing arms mount to the main chassis and hold the left and right rear wheels. The trailing arms provide suspension for the rear of the vehicle. The advantage of the stabilizer bar is a reduction in the lateral sway normally associated with three-wheeled vehicles having one wheel in the front and two wheels in the back. Reduced sway also reduces the risk of vehicle roll-over accidents.

The trailing arm assembly and the front fork assembly have suspension on all three wheels. On the fork assembly, two fork tubes contain springs which absorb the impact of obstacles and uneven surfaces. The trailing arm assembly has two springs mounted on either trailing arm. These springs absorb shocks caused by either of the rear wheels hitting obstacles and uneven surfaces. The advantage of this suspension is a reduction in rider fatigue. Also, the rider is less likely to lose control of the vehicle when the vehicle strikes a large obstacle in its path.

The handle bar assembly includes the handle bars and a hinge that allows the handle bars to be folded down for storage and shipping. The hinge mounts to the steer tube in the fork assembly and also mounts to an automotive grade latch. This latch captures a pin that is bolted to the handle bars. When the latch is released, the handlebars fold down. When the latch and pin are engaged, the handlebars will remain upright. The advantage is that the vehicle can be loaded into the back of a standard SUV or can be shipped in a smaller container thereby reducing shipping costs.

The powertrain electronics and battery pack are enclosed in the main chassis. The vertical member of the main chassis is used to house the powertrain electronics. The horizontal member of the main chassis houses the battery pack. The advantage of using the main chassis to house electronics is increased protection against inclement weather as well as routine washing of the vehicle to clean its interior and exterior.

The battery pack and powertrain electronics plate are separate components and are integrally designed as part of the main chassis. The battery pack is removable without tools by depressing a hand latch and removing the battery pack from the primary horizontal member of the main chassis. The powertrain electronics plate contains the powertrain electronic components for the vehicle and is fastened to the vertical member of the main chassis using standard screws. It is removable with common hand tools. The advantage of this easily removable battery pack and powertrain electronics plate is that routine maintenance and repair can be done by the end-user thereby reducing costly visits by and to professional electric vehicle service persons and locations.

There are four sub-assemblies for the vehicle. They are the front fork assembly, handlebar assembly, trailing arm assembly, and main chassis. These four sub-assemblies are fastened together using widely available hardware and common hand tools. Unlike prior designs, these sub assemblies do not require complex fabrication techniques such as welding in order to complete final assembly. The advantage is reduced labor costs for final assembly during the manufacturing process.

The above describes the technical characteristics of this invention based on the preferred embodiment as described in this patent. However, experts familiar with this technique are allowed to change and modify this invention as long as they do not depart from the spirit and principle of this invention. Any change and modification may still be confined to the following scope defined by the present patent.

### BRIEF DESCRIPTION OF SEVERAL VIEWS OF THE DRAWINGS

FIG. 1 is a perspective view of the invention.

FIG. 2 is an exploded perspective view of the invention.

FIG. 3 is a perspective view of the trailing arm assembly.

FIG. 4 is a perspective view of the trailing arm assembly attached to the main chassis.

FIG. 5 is a perspective view of the main chassis.

FIG. 6 is a perspective view of the front fork assembly.

FIG. 7 is a partial magnified view of the head tube portion of the front fork assembly.

FIG. 8 is a side view of the handlebar assembly in the upright position

FIG. 9 is a side view of the handlebar assembly in the folded down position

FIG. 10 is a partial magnified view of the hinge at the base of the handlebar assembly (upright position).

FIG. 11 is a partial magnified view of the hinge at the base of the handlebar assembly (folded down position).

FIG. 12 is a perspective view of the powertrain electronics plate.

FIG. 13 is an exploded perspective view of the powertrain electronics plate separated from its location in the main chassis.

FIG. 14 is a perspective view of the powertrain electronics plate installed in the main chassis.

FIG. 15 is an exploded perspective view of the battery pack separated from its location in the main chassis.

FIG. 16 is a perspective view of the battery pack in its enclosure in the main chassis.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

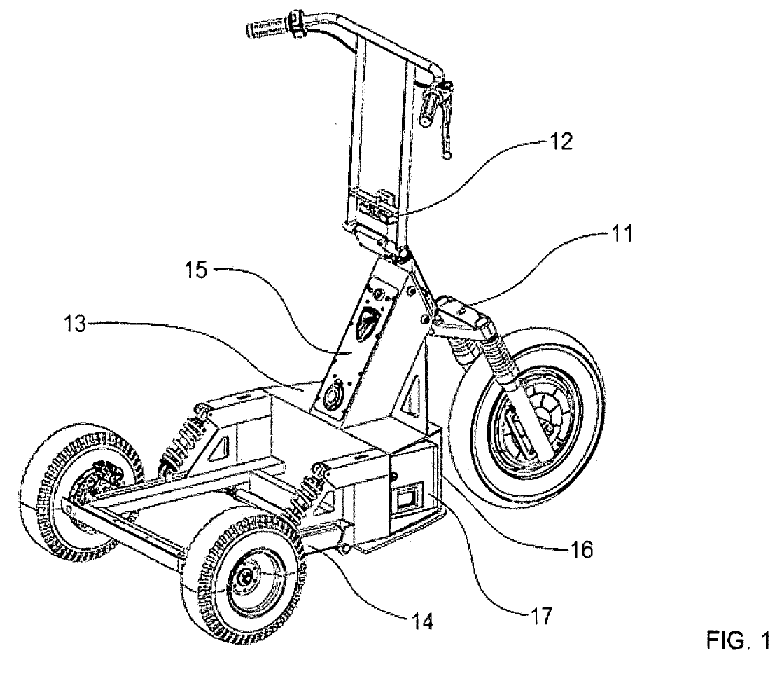

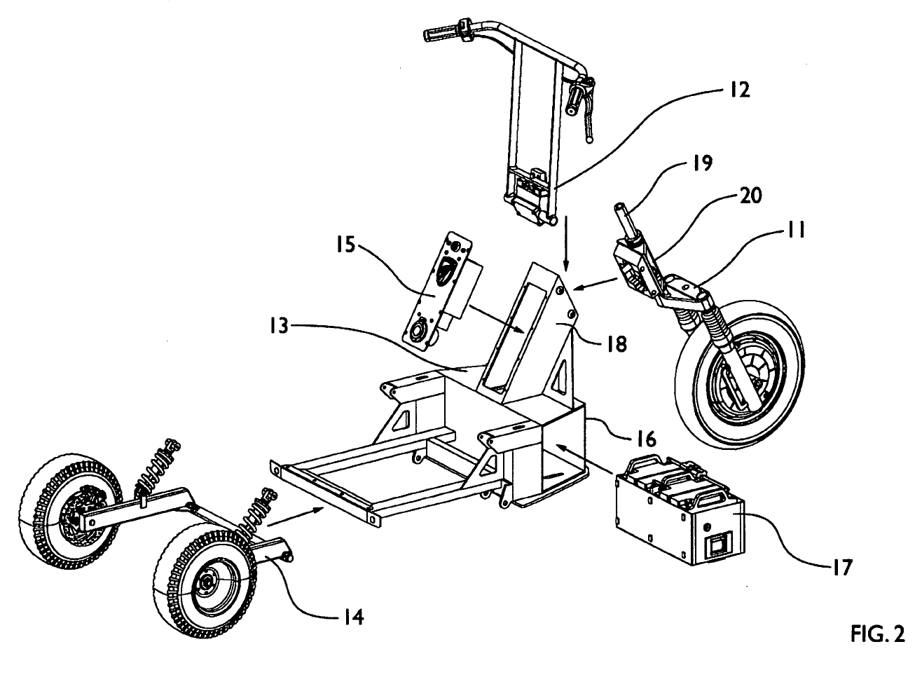

As shown in FIGS. 1-2, an electric vehicle with modular chassis embodied in the present invention comprises a front fork assembly 15, and 11, a handlebar assembly 12, a main chassis 13, a trailing arm assembly 14, an electronics plate a battery pack 17. Among these, the front fork assembly 11 is bolted to the main chassis 13. The handlebar assembly 12 is fastened to the steer tube 19 which protrudes from the top of the head tube 20. The trailing arm assembly 14 bolts to the main chassis 13 and pivots to provide suspension for the rear of the vehicle. The powertrain electronics plate 15 fastens into the primary vertical chassis member 28. The battery pack 17 slides into the primary horizontal chassis member 29. By placing the battery pack 17 inside the primary horizontal chassis member 29, the battery pack 17 is protected against impact and water damage. By placing the electronics plate 15 inside the primary vertical chassis member 28, the components on the electronics plate 15 are also protected against impact and water damage.

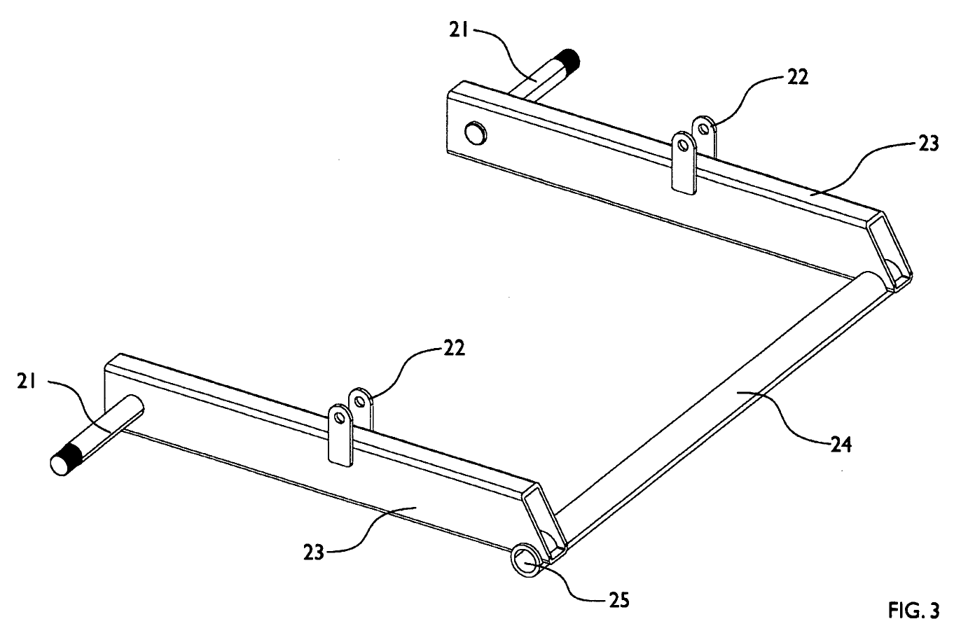

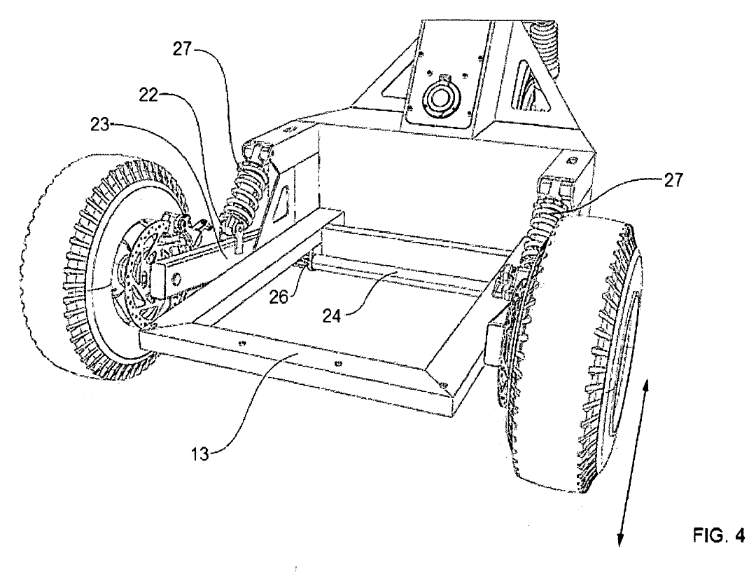

As shown in FIGS. 3-4, a trailing arm assembly 14 comprises two trailing arms 23 that support rear wheel axles 21. Right and left rear wheels are mounted to the rear wheel axles 21 on the trailing arms 23. A lower shock mount 22 is welded to each of the trailing arms 23. The trailing arms 23 are connected with a stabilizer tube 24. The trailing arm assembly 14 is mounted to the main chassis 13 at the trailing arm assembly pivot point 25. Main chassis mount for trailing arm assembly 26 secures the trailing arm assembly 14 to the main chassis 13 and allows it to pivot about the center of the stabilizer tube 24 axis. Rear shock absorbers 27 are bolted to the lower shock mount 22 and the upper shock mount 30 to allow the trailing arm assembly 14 to provide suspension for the rear of the vehicle. The stabilizer tube 24 connects the trailing arms 23 and causes both to pivot synchronously.

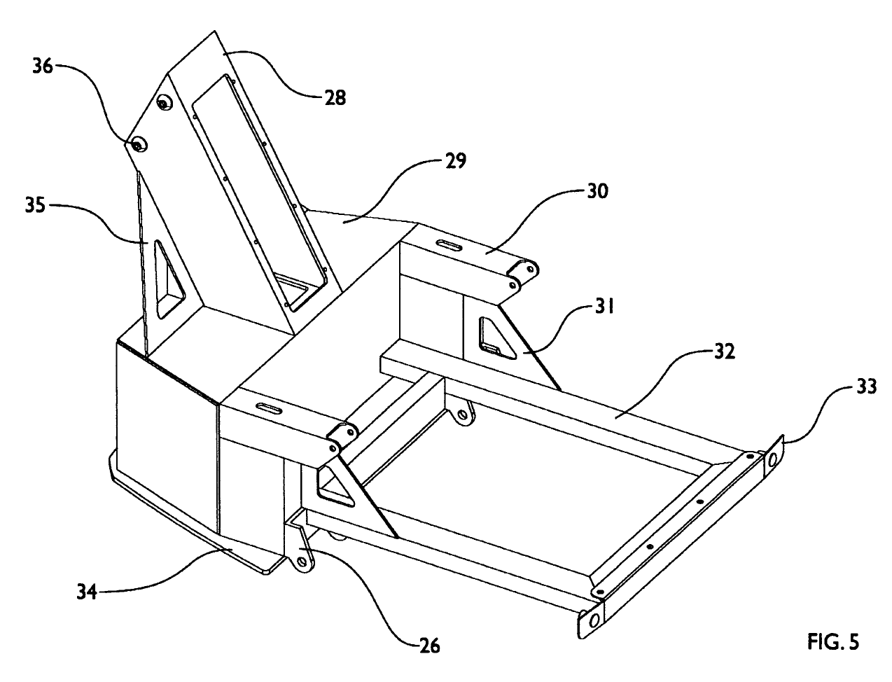

As shown in FIG. 5, the main chassis 13 is constructed using several standard aluminum extrusions. Two relatively large extrusions make up the core structure of the main chassis 13. The primary horizontal chassis member 29 and the primary vertical chassis member 28 serve dual purposes. They firstly provide structural support to the entire vehicle and secondly house the battery pack 17 and the electronics plate 15. Upper shock mounts 30 are welded to the primary horizontal chassis member 29 and the platform gusset 31. This welded structure supports the rider platform 32 where the rider of the vehicle will sit or stand. Neck gussets 35 are welded to the primary vertical chassis member 28 and the primary horizontal chassis member 29 to strengthen the chassis. A skid plate 34 is welded to the bottom of the primary horizontal chassis member 29 to protect the vehicle from severe impact with pathway hazards. A rear bumper 33 is bolted to the rear of the main chassis 13. Head tube bolts 36 fasten and seal the head tube 20 to the primary vertical chassis member 28. The trailing arm assembly 14 is bolted to the main chassis 13 using the main chassis mounts for the trailing arm assembly 26. This mount uses bushings to allow the trailing arm 23 to pivot about the trailing arm pivot point 25.

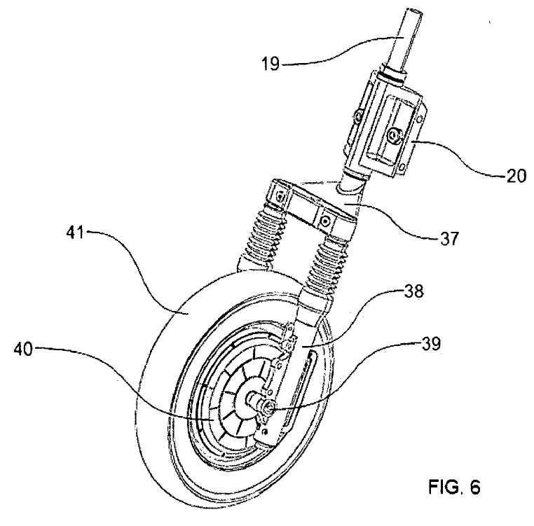

As shown in FIG. 6, the front fork assembly 11 comprises a steer tube 19, a head tube 20, a fork crown 37, two front shock absorbers 38, a front wheel axle 39, a traction motor 40, and a front tire 41. The steer tube 19 pivots to allow the rider to steer the vehicle by turning the front wheel. The head tube 20 retains the steer tube 19 using standard bearings and collars. The steer tube 19 is press fit into the fork crown 37 and then welded in place. The front shock absorbers 38 are tightly clasped by the fork crown 37 using automotive grade bolts. The front wheel axle 39 is affixed to both front shock absorbers 38 using automotive grade bolts and is an integral part of the traction motor 40. The traction motor 40 is designed to be used as a wheel and is outfitted with a standard tire rim for direct mounting of the front tire 41 to the traction motor 40.

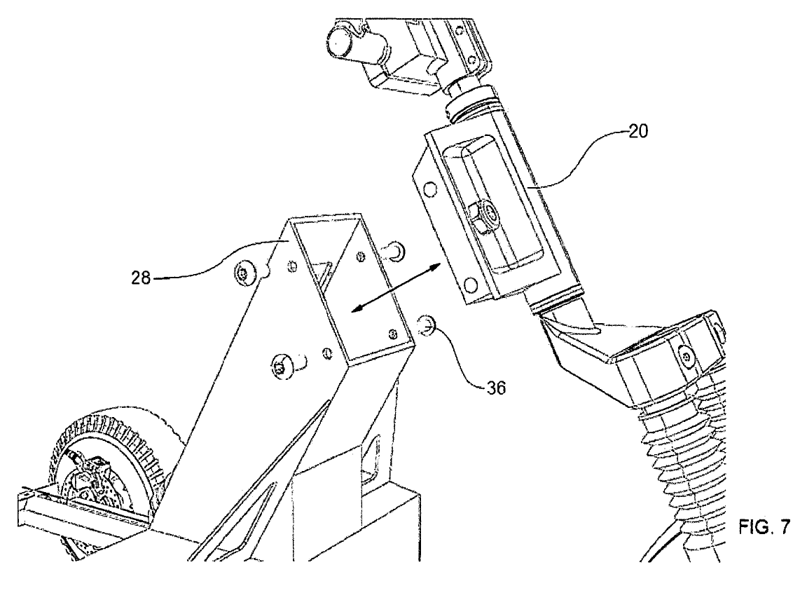

As shown in FIG. 7, the head tube 20 mounts to the primary vertical chassis member 28 using head tube bolts 36. This assembly mates the front fork assembly 11 to the main chassis 13.

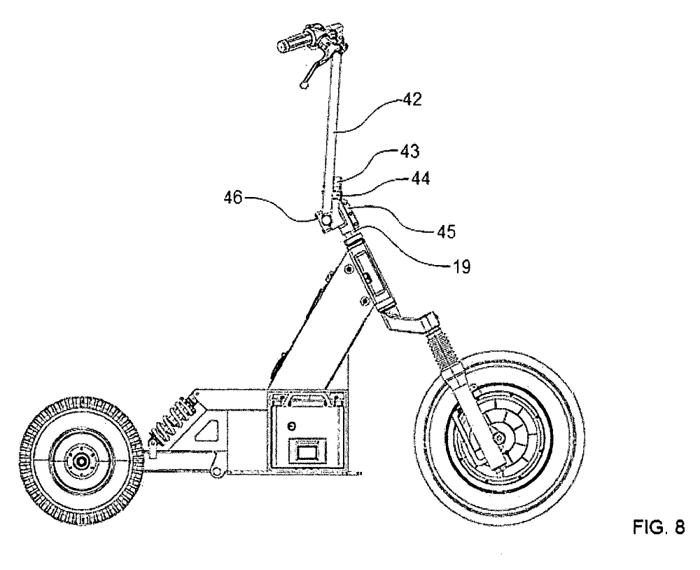

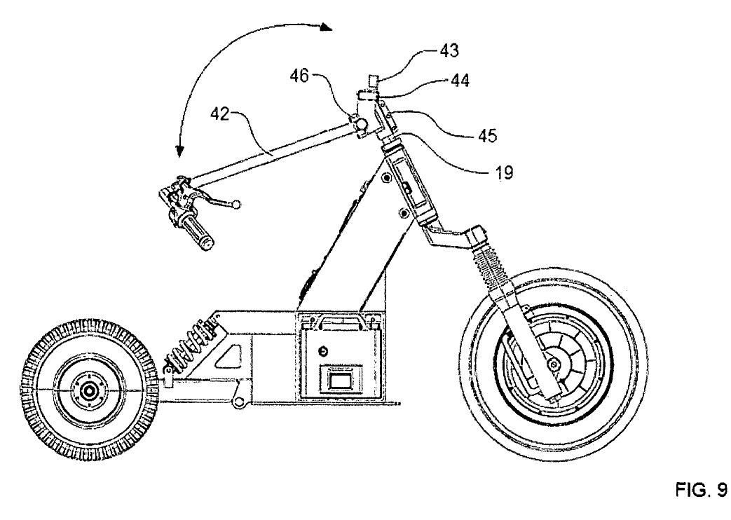

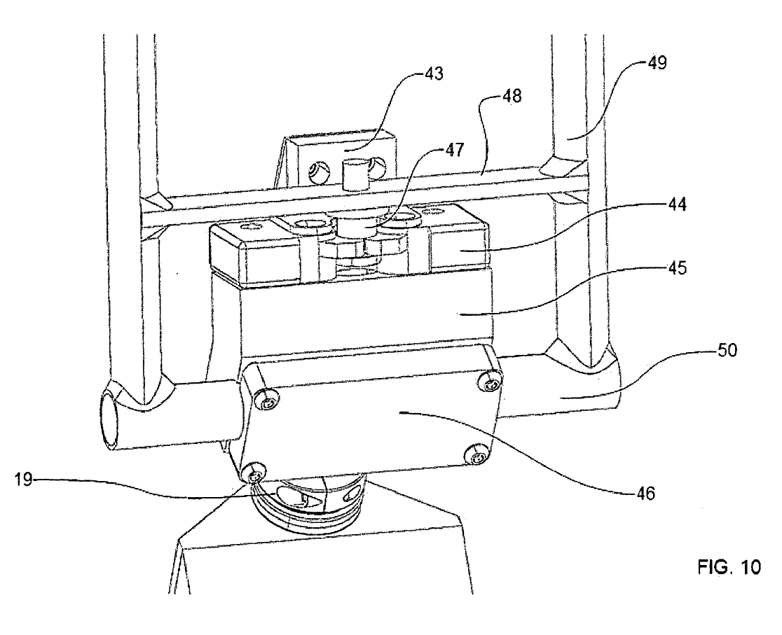

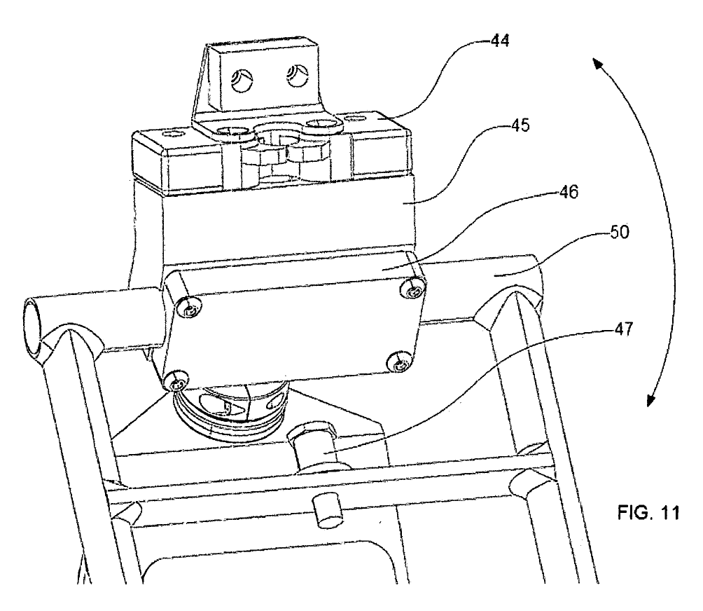

As shown in FIGS. 8-11, the handlebar assembly 12 comprises the handlebars 42, handlebar latch stop 43, handlebar latch 44, handlebar hinge 45, and handlebar retaining plate 46. The handlebar assembly 12 is attached tightly to the front fork assembly 11 to enable the rider to use the handlebars 42 to steer the vehicle. The handlebar hinge 45 is slipped over the steer tube 19 and grips the steer tube 19 by tightening three bolts along its collar. The handlebars 42 swivel from an upright position to a folded down position. The handlebar latch 44 contains a lever that is manually activated by the rider. Upon activation, the handlebar latch 44 releases the handlebar latch bolt 47 and the handlebars will pivot about the axis of the handlebar pivot tube 49. The handlebar latch bolt 47 is held to the handlebars by the handlebar bolt cross bar 48. The handlebar bolt cross bar 48 is welded to the handlebar vertical tube 50.

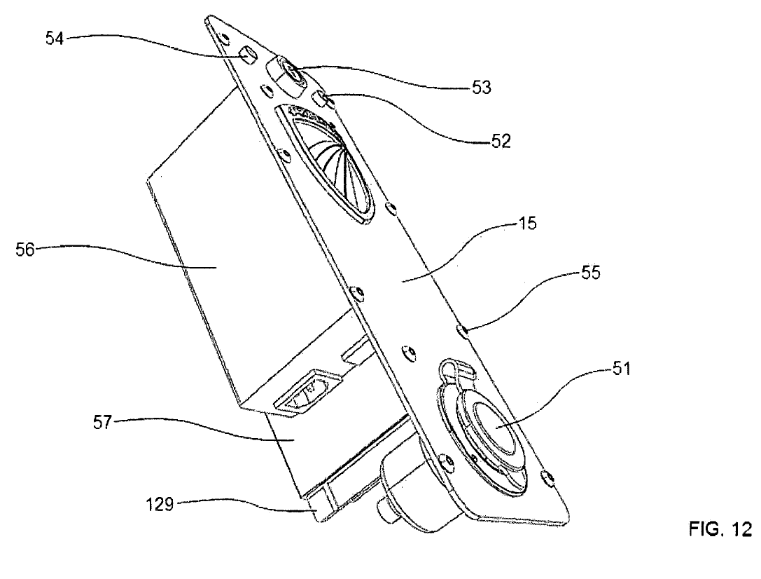

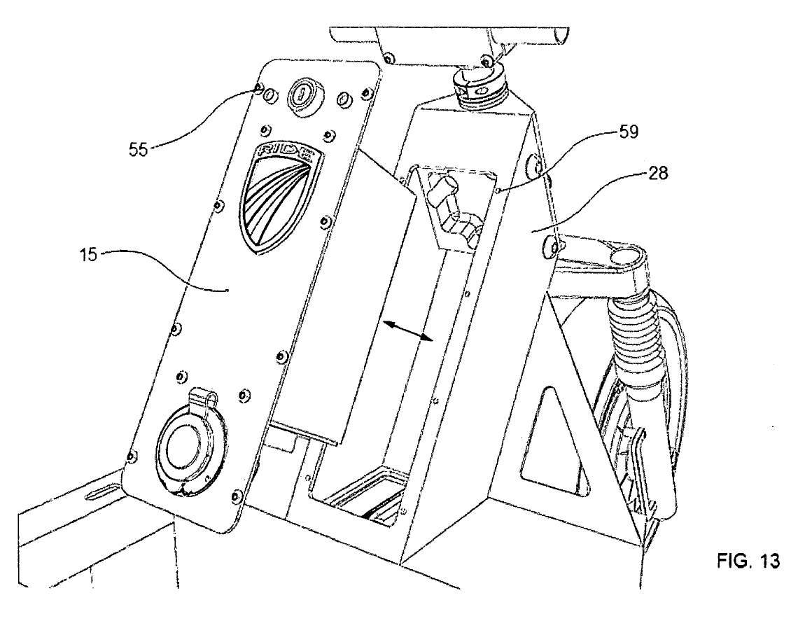

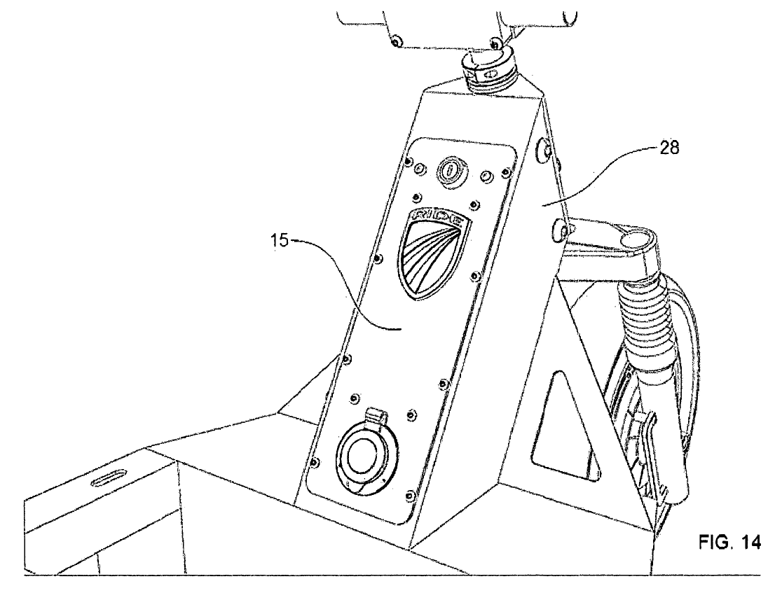

As shown in FIGS. 12-14, the electronics plate 15 comprises the electronics charge port 51, on/off LED 52, key switch 53, charge indicator LED 54, battery charger 56, motor controller 57, and electronics fuse block 58. These electronics components are held to the electronics plate 15 using mounting brackets and or industrial adhesives. The electronics plate 15 is installed into the primary vertical chassis member 28 turning the electronic plate bolts 55 into the electronics plate bolt holes 59. Ergo the primary vertical chassis member 28 also serves as the electronics enclosure 18.

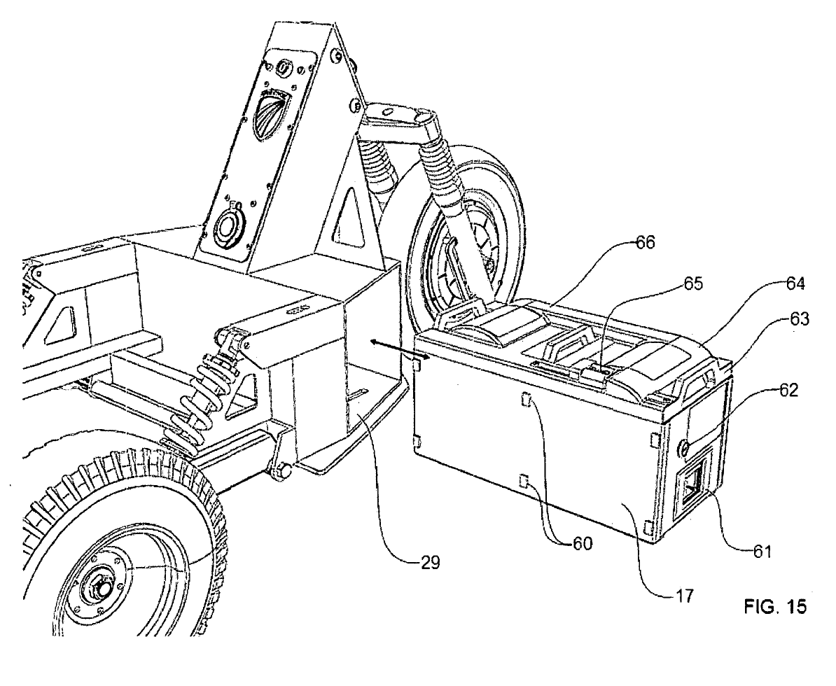

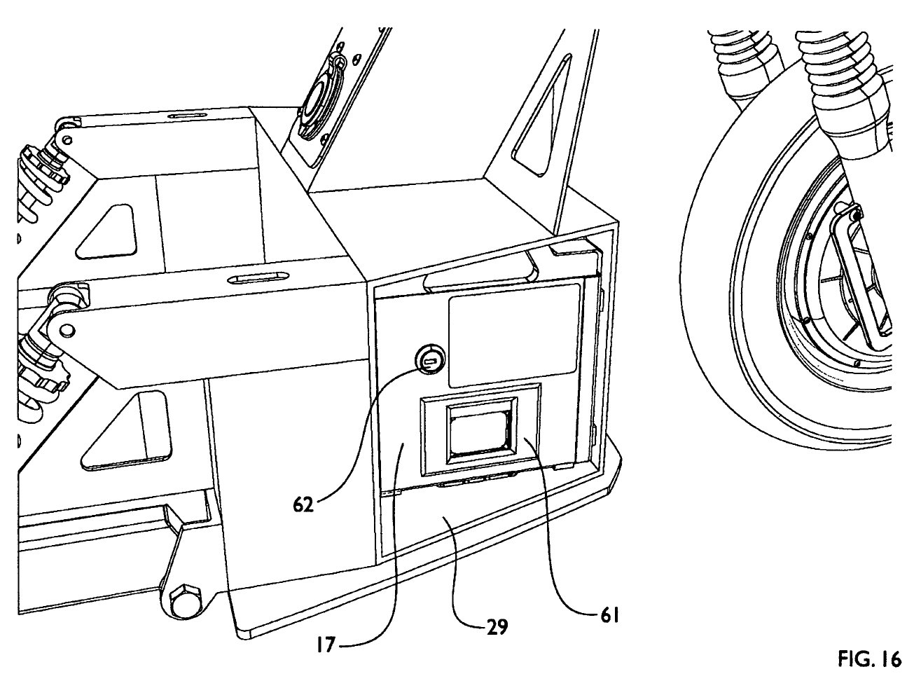

As shown in FIGS. 15-16, the battery pack 17 comprises battery guides 60, battery pack latch 61, battery pack lock 62, battery pack handle 63, battery pack cover 64, battery pack connector 65, battery pack fuse block 66 and 4 standard 12 volt lead acid batteries. Using the battery pack guides 60, the battery pack 17 slides into the primary horizontal chassis member 29 which also serves as the battery enclosure 16. As it slides into the primary horizontal chassis member 29, the battery pack latch 61 deploys into a slot in the bottom surface thereby fixing the position of the battery pack 17. The rider may choose to lock the battery pack 17 into the primary horizontal chassis member 29 by using the battery pack lock 62. The rider may remove the battery pack 17 by unlocking the battery pack lock 62 and actuating the battery pack latch 61 by hand and pulling the battery pack 17 out using the battery pack handles 63.

We claim:

1. A vehicle comprising:
an electric propulsion system having an energy storage system, a power conversion system, and one or more electric traction motors;
a plurality of wheels;
suspension systems on one or more of the wheels;
a steering apparatus;
a braking system comprising mechanical brakes, electromagnetic regenerative brakes or both;
a platform for one or more riders to sit or stand;
a throttle that controls the electric propulsion system; and
structural members of its chassis made from standard metal extrusions that serve as primary structural chassis members for the entire vehicle and also serve as enclosures for the electronic systems of the vehicle.

2. The system in claim 1, wherein the power conversion systems, housed in the primary structural chassis members, are fastened to a mounting plate and are removable as a single unit from their chassis enclosure using hand held tools.

3. The system in claim 1, wherein the energy storage system, housed in the primary structural chassis members, is removable as a single unit from its chassis enclosure.

4. The system in claim 1, wherein the energy storage system, housed in the primary structural chassis members, is removable as a single unit from its chassis enclosure using hand-operated levers and without the assistance of any tools.

5. The system of claim 1, wherein a handlebar assembly comprises a mechanical device that allows the rider to fold down the handlebar assembly using hand-operated levers and without the assistance of any tools.

6. The system in claim 1, wherein the head tube is removable from the main chassis using standard bolts.

7. A system in claim 1, wherein the front of the vehicle has suspension components that are bolted to the front wheel(s) and also to a fork crown

8. A system in claim 1, wherein the rear of the vehicle has suspension components that are bolted to the trailing arms and also to the main chassis

9. A system in claim 1, wherein the vehicle is comprised of four modular sub-assemblies defined as a front fork assembly, a handlebar assembly, a main chassis, and a trailing arm assembly, all of which are bolted together using standard bolts and commonly available hand tools.

10. The system of claim 1, wherein a trailing arm design is used for the rear suspension of the vehicle

11. The system of claim 10, wherein a stabilizer tube connects the two trailing arms that make up the rear suspension of the vehicle.

12. A folding handlebar assembly comprising:
handlebars with two vertical tubes, one horizontal tube used for pivoting and one horizontal bar used to hold a latch bolt;
handlebar hinge comprising a semi-cylindrical recess for positioning the horizontal pivot tube, mounting holes for a handlebar retaining plate, mounting holes for fastening a latch mechanism, and a collar for gripping a steer tube;
handlebar hinge plate that bolts to the handlebar hinge;
a latching mechanism;
a hand release lever on the latching mechanism;
a latch bolt; and
a latch stop that mounts to the top of the latching mechanism.

13. A vehicle comprising:
an electric propulsion system having an energy storage system, a power conversion system, and one or more electric traction motors;
a plurality of wheels;
suspension systems on one or more of the wheels;
a steering apparatus;
a braking system comprising mechanical brakes, electromagnetic regenerative brakes or both;
a platform for one or more riders to sit or stand;
a throttle that controls the electric propulsion system; and
a trailing arm suspension comprising two trailing arms and a perpendicular tube connecting the two trailing arms that strengthens the lateral stability of the vehicle.
